(19) United States
(12) Patent Application Publication
(10) Pub. No.: US 2005/0160603 A1
(43) Pub. Date: Jul. 28, 2005

(54) Knife

(76) Inventor: William Alfred Ireland, Gloucester (GB)

Correspondence Address: JOEL D. SKINNER, JR.;SKINNER AND ASSOCIATES, 212 COMMERCIAL ST., HUDSON, WI, 54016, US

(21) Appl. No.: 10/851,344

(22) Filed: May 21, 2004

(30) Foreign Application Priority Data
May 23, 2003 (GB) GB 0311866.8

(51) Int. Cl. B26B 29/00

(52) U.S. Cl. 30/2; 30/294

(57) ABSTRACT

A knife comprising a first side element 10, a second side element 20, the first and second side elements 10, 20 defining therebetween a channel 36 across at least a part of which a cutting edge of a blade extends 38, wherein the second side element 20 is moveable relative to the first side element 10 to vary the width of the channel 36.

This invention relates to a knife, and in particular to a knife suitable for use, for example, in the opening of bags or sacks and in which the cutting edge of the knife blade is protected or guarded to minimize the risk of injury to a user.

Bag knives and similar devices are commonly used to open bags, sacks or other packaging or the like by removing an edge of the bag, sack or the like. Traditionally the knives used to perform these operations include an exposed blade. Obviously, where a knife with an exposed blade is used, there is the risk of injury to a user of the knife, for example resulting from the user's fingers or hands coming into contact with the exposed blade. Increasingly, where knives are used by employees, employers must take steps to ensure that the risk of injury to the employees at work is minimized, and so the use of knives with exposed blades in this type of operation is becoming unacceptable.

A number of bag knives are known in which a guard is provided to prevent certain objects from coming into contact with the cutting edge of the blade, thereby reducing the risk of injury. One knife of this type comprises a body defining a channel, a blade being carried by the body and arranged so that a portion of the cutting edge extends across at least a part of the channel. The remainder of the blade is covered by the body. The dimensions of the channel are such that, for example, a user's fingers will not fit into the channel. As a result, the user's fingers cannot come into contact with the cutting edge of the blade and so the risk of injury to the user is reduced. Although such a knife reduces the risk of injury to the user, the size of the channel may be restrictive resulting in the knife only being suitable for use with certain relatively thin materials. Where it is difficult to introduce the material to be cut using the knife into the channel, then an employee may be tempted to either use a knife with an unprotected blade, or to modify the knife, for example to increase the size of the channel, and a point may be reached at which a user's fingers could fit within the channel. Clearly, in such circumstances, there is again a risk of injury to the user.

It is an object of the invention to provide a knife suitable for use as a bag knife in which the disadvantageous effects described hereinbefore are reduced.

According to one aspect of the invention there is provided a knife comprising a first side element, a second side element, the first and second side elements defining therebetween a channel across at least a part of which a cutting edge of a blade extends, wherein the second side element is moveable relative to the first side element to vary the width of the channel.

By providing a knife of this type, in normal use the channel is sufficiently small that the risk of injury is minimized, and only where a thicker material is to be cut is the size of the channel expanded to a point where the blade is not fully guarded.

The side elements are conveniently spring biased towards one another. Conveniently the side elements are pivotally connected to one another, preferably at a location spaced from a plane of the blade.

The side elements may be shaped such that the width of the channel is increased at one end of the knife.

Preferably substantially the full cutting edge of the blade is exposed within the channel. The blade is conveniently mounted within the knife in such a manner as to be removable to allow replacement thereof in the event that the cutting edge becomes blunt or damaged.

According to another aspect of the invention there is provided a knife comprising first and second side elements defining therebetween a channel across at least part of which a cutting edge of a knife blade extends, wherein substantially the full cutting edge of the knife blade is exposed within the channel.

According to a further aspect of the invention there is provided a knife comprising first and second side elements defining therebetween a channel across at least part of which a cutting edge of a knife blade extends, wherein the first and second side elements are shaped such that the width of the channel is greater adjacent one end of the side elements.

The side elements are conveniently substantially parallel, other than at said one end.

It will be appreciated that such flaring of the side elements assists in introducing the material to be cut into the channel, and so may reduce the regularity with which the side elements need to be separated to increase the width of the channel, thereby further reducing the risk of injury to a user.

The invention will further be described, by way of example, with reference to the accompanying drawings, in which:

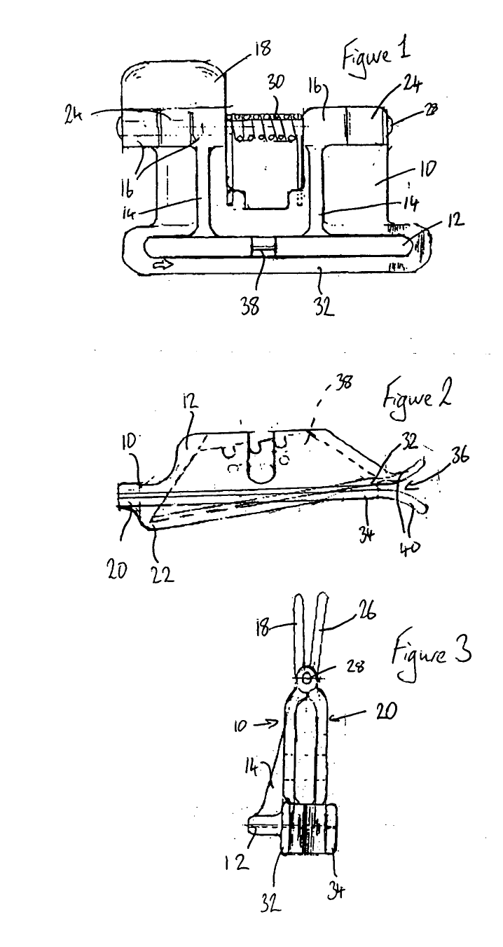

FIG. 1 is a side view of a knife in accordance with an embodiment of the invention;

FIG. 2 is a bottom view of the knife of FIG. 1;

FIG. 3 is a end view of the knife of FIG. 1;

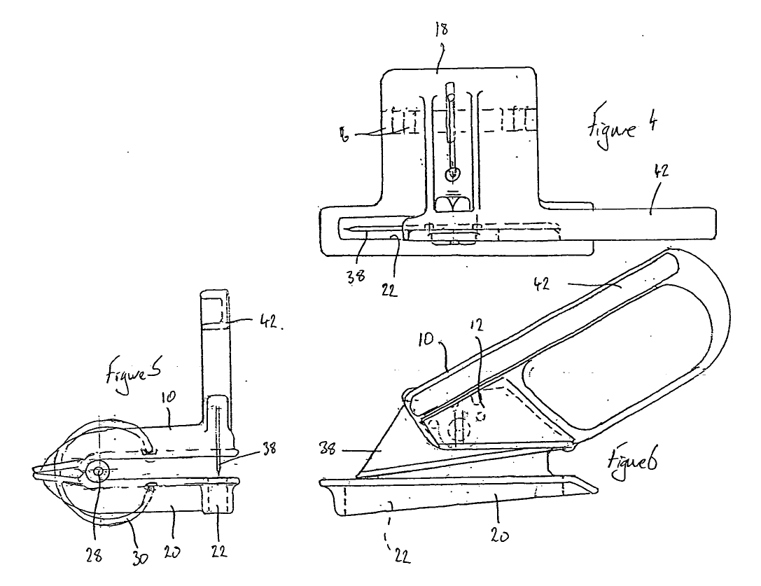

FIGS. 4, 5 and 6 are top, side and end views, respectively of a knife according to a second embodiment, the knife being illustrated in its open, blade exposed condition; and

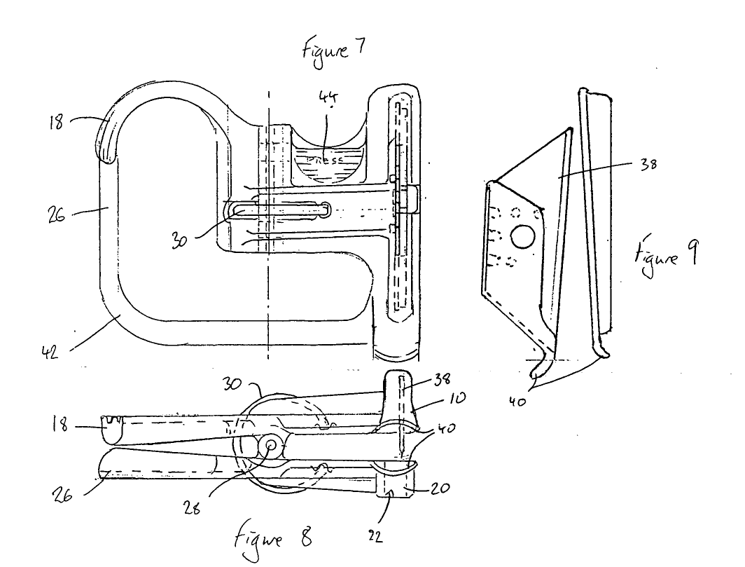

FIGS. 7, 8 and 9 are top, end and side views of a further embodiment, again with the knife shown in its open condition.

Referring to FIGS. 1 to 3, a bag knife is shown which comprises a first side component 10 comprising a plastics molding of generally planar form but including a blade housing part 12 located adjacent a lower edge of the component 10. Upstanding ribs 14 are provided to increase the rigidity of the component 10. The component 10 further includes a pair of hinge regions 16, and an actuator region 18.

The knife further includes a second side component 20 which is similar to the first side component 10, but in which the blade housing part 22 is of a different shape, and the ribs are omitted. Again, hinge regions 24 and an actuator region 26 are provided.

The hinge regions 16, 24 of the side components 10, 20 are shaped to cooperate with one another to define, with a pivot pin 28, a hinge or pivotal connection between the side components 10, 20. As shown in FIG. 1, the location of the hinge regions 16, 24 is such as to define a space within which a spring 30 is provided to bias the side components 10, 20 towards a position in which the blade housing parts 12, 22 thereof are adjacent one another. Movement of the components 10, 20 away from this position is achieved by squeezing the actuator regions 18, 26 towards one another. The lengths of the various parts of the components 10, 20 are chosen such that when the ends of the actuator regions 18, 26 are moved into abutment with one another, the spacing of the blade housings is increased by double the distance moved by the ends of the actuator regions 18, 26. Thus, for example, if the ends of the actuator regions 18, 26 are initially spaced apart from one another by 3 mm, then the action of squeezing the actuator regions 18, 26 together will increase the separation of the blade housings 12, 22 by 6 mm.

Each side component 10, 20 is shaped, adjacent the respective blade housing, to define a respective side element 32, 34. The side elements 32, 34 extend generally parallel to one another and define therebetween a channel 36. A blade 38, typically of trapezoidal shape, is secured within the blade housing part 12 of the first side component 10 such that the cutting edge of the blade is located, substantially completely, within and extending across at least a part of, and preferably completely across, the channel 36. As shown in FIG. 2, the blade 38 extends into the blade housing 22 of the second side component 20, the inside of which is shaped to conform, generally, with the shape of the part of the blade 38 received therein.

At one end of the channel 36, the side elements 32, 34 are shaped such that the channel 36 is of flared form, this being achieved by shaping each side element 32, 34 to include a region 40 which is bent outwardly compared to the remainder of each side element 32, 34.

In normal use, where the knife is used to open, for example, a bag of a relatively thin material, the bag material is introduced into the flared region of the channel 36 and the knife is moved relative to the bag material to draw the bag material along the channel 36 and into contact with the blade 38, the edge of the bag material passing between the components 10, 20 between the plane of the blade 38 and the pivot pin 28. It will be appreciated that continued movement will cause the bag material to be cut by the blade 38, and hence that by moving the knife relative to the bag material across the full width of the bag material, the bag will be fully opened.

The cutting edge of the blade 38 is angled to the direction of movement of bag material along the channel by a relatively small amount, and so there is relatively little resistance to movement of the knife relative to the bag material. Even if the bag material is not immediately cut upon engagement with the blade, as the material slides along the length of the cutting edge of the blade, cutting of the material is likely to take place. As substantially the full length of the cutting edge of the blade 38 is located within and exposed within the channel 36, it will be appreciated that the likelihood of the material being cut is maximized, and also that the blade is used efficiently.

Where the knife is used to cut thicker materials, one mode of operation is to use the knife as described hereinbefore. If used in this manner, then the action of feeding the material into the channel 36 via the flared end thereof may result in the side elements 32, 34 being forced apart from one another to accommodate the material, the side components 10, 20 undergoing pivotal movement relative to one another against the action of the spring. A second mode of operation is for the user to squeeze the actuator regions 18, 26 together to cause pivotal movement of the side components 10, 20 to occur, this movement causing the side elements 32, 34 to separate from one another to increase the width of the channel 36. The material can then be fed into the channel 36 and cut as described hereinbefore. In either mode of operation, although the degree of protection afforded to the user may be slightly less than when the knife is used to cut a relatively thin material, the blade is still only exposed within the channel 36, and as the channel 36 is of a restricted size, the risk of injury is still low.

In the illustrated embodiment, the blade 38 is secured within the blade housing part 12 by a screw (not shown) which passes through an opening provided in the blade 38. If the blade 38 becomes worn or damaged, then the blade may be removed from the knife by releasing the screw. Once the screw has been removed, the blade 38 can be withdrawn from the knife, and this is achieved by drawing the blade 38 through a slot (not shown) formed in the blade housing part 22 of the second side component 20 at a location aligned with the blade, in use. After removal of the blade, a new blade can be introduced into the knife by reversing the procedure outlined above, the new blade finally being secured in position using the screw. Although the knife described includes a removable, replaceable blade, this need not be the case and the knife could be designed to include a fixed blade, the knife being disposed of in the event that the blade becomes worn or damaged.

It will be appreciated that a number of modifications may be made to the knife described hereinbefore within the scope of the invention. By way of example, although the illustrated arrangement includes a coiled spring, other resilient spring devices could be used to provide the biasing force urging the components 10, 20 towards one another. Further, the shapes of the side components could be modified, for example, so that the provision of a pivot pin can be avoided whilst retaining the feature that the components are pivotally mounted upon one another. Another feature which could be provided is a latch arranged to allow the components to be held in the condition in which the channel is of enlarged width, and if desired, a trigger mechanism could be included to allow release of the latch.

FIGS. 4, 5 and 6 illustrate an arrangement that, in many aspects is similar to that of FIGS. 1 to 3, and the like reference numerals are used to denote like parts. The main differences are that the coiled spring of FIGS. 1 to 3 has been replaced by a simple length of a resilient metallic material bent to be of “C” shaped form, thereby allowing a reduction in the length of the product, and that the first side component 10 is shaped to define a handle 42 to assist in gripping and use of the product. Further, although the cutting edge of the blade 38 is guarded, a large part of the sides of the blade 38 is exposed with the result that the angle of attack of the blade 38 against the material being cut can be changed, by tilting of the knife, by a relatively large amount.

FIGS. 7, 8 and 9 illustrate a further variant which, like that of FIGS. 4 to 6, includes a handle 42. However, in the arrangement of FIGS. 7, 8 and 9 the handle forms part of one of the actuator regions 18, 26, thus assisting in single handed operation of the knife. In the arrangement of FIGS. 4 to 6, difficulties may be faced in moving the knife using the handle at a time when the actuator regions require squeezing together. A further difference is that a thumb/finger location 44 has been provided to allow the force of the spring 30 to be supplemented, manually, by squeezing the components 10, 12 together.

As with the arrangement of FIGS. 4 to 6, the component 20 conveniently defines a channel 22 through which the blade 38 can be extracted for replacement. The blade may be fitted into a carrier which can be snap-fitted to the component 10 and released therefrom by pressing a button to deflect a lever thereby disengaging the carrier from the component 10.

A range of further modifications and alterations are possible. For example, a double-ended knife is envisaged in which a second guarded blade is mounted to the actuator regions such that when the components 10, 20 are spaced apart at one end of the knife, they are brought close to one another at the other end of the knife.

1. A knife comprising a first side element, a second side element, the first and second side elements defining therebetween a channel across at least a part of which a cutting edge of a blade extends, wherein the second side element is moveable relative to the first side element to vary the width of the channel.

2. A knife according to claim 1, wherein the side elements are spring biassed towards one another.

3. A knife according to claim 1, wherein the side elements are pivotally connected to one another.

4. A knife according to claim 1, wherein the side elements are connected to one another at a location spaced apart from a plane of the blade.

5. A knife according to claim 1, wherein the side elements are shaped such that the width of the channel is increased at one end of the knife.

6. A knife according to claim 1, wherein substantially the full cutting edge of the blade is exposed within the channel.

7. A knife according to claim 1, wherein the blade is mounted within the knife in such a manner as to be removable to allow replacement thereof.

8. A knife comprising first and second side elements defining therebetween a channel across at least part of which a cutting edge of a knife blade extends, wherein substantially the full cutting edge of the knife blade is exposed within the channel.

9. A knife comprising first and second side elements defining therebetween a channel across at least part of which a cutting edge of a knife blade extends, wherein the first and second side elements are shaped such that the width of the channel is greater adjacent one end of the side elements.

10. A knife according to claim 9, wherein the side elements are substantially parallel, other than at said one end.
